(19) United States
(12) Patent Application Publication
(10) Pub. No.: US 2003/0047126 A1
(43) Pub. Date: Mar. 13, 2003

(54) System for identifying medical devices

(76) Inventor: Daniel K. Tomaschko, Savage, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/242,272

(22) Filed: Sep. 12, 2002

Related U.S. Application Data
(60) Provisional application No. 60/322,481, filed on Sep. 12, 2001.

(51) Int. Cl. G01D 13/00

(52) U.S. Cl. 116/201; 116/200

(57) ABSTRACT

A method and system for identifying medical devices comprising the steps of providing at least one medical device with at least one characteristic and providing the at least one medical device with at least one visible color, wherein the at least one characteristic corresponds to the at least one visible color. A key may be provided which lists the potential visible colors and the corresponding characteristics.

### CROSS-REFERENCE TO RELATED APPLICATIONS

This application is a utility application claiming priority from provisional application U.S. 60/322481 filed Sep. 12, 2001, the entire contents of which is incorporated herein by reference.

### STATEMENT REGARDING FEDERALLY SPONSORED RESEARCH

Not Applicable

### BACKGROUND OF THE INVENTION

Numerous systems and methods exist for identifying objects. More specifically, there are numerous systems in which specific colors and patterns may be used to designate specific characteristics of various items. Such use of color for purposes of identification is often referred to as color coding.

One use of color coding is in the field of electrical wiring. In wiring schemes, a system of standardized colors and color patterns are used to identify the function and/or type of wire, or wires, which underlie the appropriately colored wire casing or harness. This sort of identification by color is well understood. More complex wiring schemes may utilize casings with other colors and/or combinations to indicate various characteristics of the respective wires.

In other areas, for example the field of medical devices and instruments, color coding may be utilized to identify particular devices or tools. For example, U.S. Pat. No. 5,573,529 describes a method of identifying metal medical instruments according to a color plan.

Color may also be used to identify particular characteristics of an individual device in order to select a particular device from a general group of devices. For example, adaptors for use with oxygen masks are known to be color coded according to the percentage of oxygen that a particular adaptor is designed to supply to the oxygen mask. An adaptor having a green color or marking may indicate that the adaptor is configured to deliver a flow of 30 percent oxygen to the mask, orange may indicate 60 percent, and pink 50 percent. Other colors may be used to indicate other percentages.

In another example, it is known that intravenous (IV) needles or the packaging thereof, may be provided with various colors to indicate the gauge of a particular needle. For example, a 20 gauge IV needle may be provided with a brown color, whereas other IV needles are provided with other colors which correspond to the particular gauge of the respective needle.

Other examples of color coding and the use of color to identify items or identify particular characteristics of one or more members of a group of items are described in the following references: U.S. Pat. No. 4,882,867, U.S. Pat. No. 3,747,603, U.S. Pat. No. 3,935,603, U.S. Pat. No. 3,840,015, U.S. Pat. No. 3,740,779, U.S. Pat. No. 4,253,830, U.S. Pat. No. 5,275,612, U.S. Pat. No. 4,202,351, U.S. Pat. No. 6,264,046, U.S. Pat. No. 6,213,299, U.S. Pat. No. 6,120,007, U.S. Pat. No. 5,982,967, and others.

The entire content of all patents listed within the present application are incorporated herein by reference.

### BRIEF SUMMARY OF THE INVENTION

The present invention may be embodied in a variety of different embodiments. Some of the embodiments of the invention are directed to the use of color to identify medical devices or more particularly to identify one or more characteristics of a medical device, thereby allowing a viewer to readily differentiate a particular medical device or group of devices from others. In some embodiments of the invention, one or more colors may be utilized to indicate one or more characteristics, features or functions of a medical device according to a color code or key. The key may be a guide which indexes the various characteristics which may be represented by a particular color or color pattern.

For example, adding a colorant to a medical device, such as a balloon would be useful in distinguishing the balloon from others and providing a readily recognizable means for product identification. A balloon, when used with a catheter, is a primary functional component of the catheter. By providing the balloon with one or more colors readily differentiates the catheter from other products by coloring the balloon based on distinguishing functional characteristics. For example workhorse balloons could be a given color, adjunctive balloons another color, delivery balloons yet another color, and so on.

Coloring of the balloon may be performed at the resin level or other level of manufacturing. Color could also be applied to the finished component or product.

In at least one embodiment of the invention, medical balloons are colored according to a particular characteristic of the balloon. Different colors may be used to indicate various elements of the balloons and/or ranges or values of such elements.

In at least one embodiment, balloons are provided with a color coding scheme wherein different colors are used to identify different compliance characteristics which a balloon may be provided with. For example, a balloon having a high compliance curve may be provided with a particular color, whereas a balloon having a lower compliance curves are provided with a different color. In this manner, the various compliance curves of a variety of balloons may be made readily apparent by the color of the balloon. As a result, a balloon with a desired compliance curve may be readily identified and easily differentiated from other balloons of having compliances.

In the same manner as compliance, other features of a balloon may be readily identified by providing the balloon with a color scheme according to the desired feature. For example, balloons may be colored to identify: the function of the balloon, the length of the balloon, the diameter of the balloon, the inflation pressure of the balloon, the expansion rate of the balloon, the shape of the balloon, the particular construction of the balloon and any other feature of the balloon which may be deemed desirable to readily identify.

The various characteristics of a medical device, such as a balloon, and the corresponding color representing the particular characteristic may be listed and cross referenced in a color code or key. The key may be embodied as an index which lists the various colors that may be provided to a balloon and also lists the characteristics which corresponds to and are represented by each color. Through the use of such a key, anyone including those wholly unfamiliar with the particular color coding system in use will be able to readily identify all of the characteristics of the balloon merely by observing the color(s) of the balloon and referencing the key.

Where a medical device has a variety of different characteristics, a color coding system may be utilized where the device may be provided with a variety of colors with each characteristic corresponding to a different color. In an alternative embodiment of the invention, a pattern or patterns of one or more colors may be used to indicate particular characteristics of the device.

Through the use of color(s) and/or patterns of color(s) any and all characteristics of a balloon or any other medical device may thus be readily identified according to the present invention.

### BRIEF DESCRIPTION OF THE SEVERAL VIEWS OF THE DRAWINGS

A detailed description of the invention is hereafter described with specific reference being made to the drawings in which:

FIG. 1 is a side elevational view of tubing which may be utilized with at least one embodiment of the present invention;

FIG. 2 is a side elevational view of a balloon which may be utilized with at least one embodiment of the present invention;

FIG. 3 is a side elevational view of a catheter which may be utilized with at least one embodiment of the present invention;

FIG. 4 is a side elevational view of a package which may be utilized with at least one embodiment of the present invention;

FIG. 5 is a front view of an example key which may be utilized with at least one embodiment of the present invention; and

FIG. 6 is a side elevational view of an implantable medical device which may be utilized with at least one embodiment of the invention.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

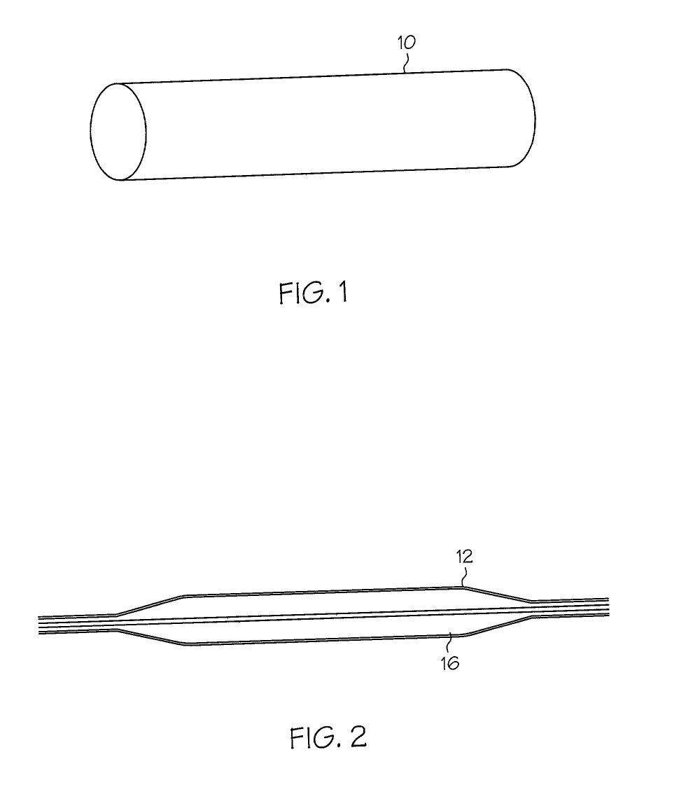

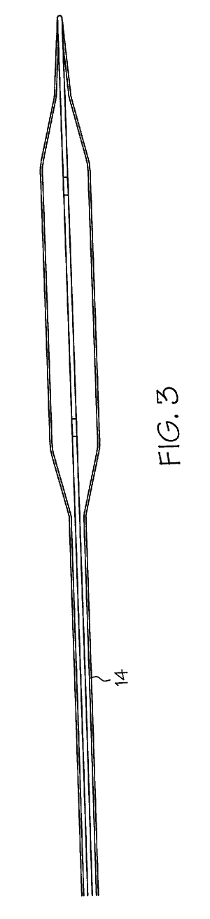

In FIG. 1, a tubular member 10, is shown. The tubular member 10 is formed from what is referred to herein as the polymeric base material, and may be comprised of any extrudable polymeric material from which medical devices such as a balloon 12, an example of which is shown in FIG. 2, and/or a catheter 14, an example of which is shown in FIG. 3, are typically produced including various polymers such as polyesters, polyamides, polyurethanes, polyurethaneureas, polyolefins such as polypropylene and polyethylene, polyolefin copolymers and terpolymers, polycarbonates, polyvinyl acetate, thermoplastic elastomers including polyether-polyester block copolymers such as the Hytrel® series of block copolymers, also referred to as thermoplastic polyester elastomers, available from DuPont in Wilmington, Del. or the Arnitel® series available from DSM, the Netherlands, such as Arnitel® 540 and polyamide/polyether/polyesters elastomers such as PEBAX® 6333, 7033 and 7233, polyvinyl chloride, polystyrene, polyacrylate, polymethacrylate, polyacrylonitrile, polyacrylamide, silicone resins, and so forth, and copolymers and blends thereof. This list is intended as an illustration of the types of materials which may be utilized in the present invention and is not intended as an exclusive list.

The tubular member 10 is shown having a predetermined color. The tubular member 10 or any portion thereof may be provided with any color desired. In at least one embodiment of the invention the color of the tubular member is provided by compounding a pigment, dye or other colorant, with the polymeric base material.

In one example, the member 10 may be provided with a blue coloring. In this example a Phthalocyanine Blue pigment, such as Sunfast Blue 15:3, available from Sun Chemical, is compounded with the polymeric base material. The pigment may comprise about 8 percent by weight of the pigment/polymeric base material compound. Alternatively the percentage by weight of the pigment mixed with the polymeric base material may be between about 1 to about 10 percent. The compound is mixed, extruded and formed into pellets. To produce the tubular member 10, the pellets are mixed with an additional quantity of clear resin material which is extruded to form the tubular member 10 wherein the pigment comprises between about 1 percent to about 10 percent by weight of the tubular member 10. In at least one embodiment of the invention, the final percentage of pigment in the extruded tubular member is about 4 percent by weight.

In a similar manner tubular member 10 may be provided with other colors such as by substituting the Sunfast Blue 15:3 pigment with other or additional pigments or colorants.

Where the tubular member 10 is formed into a balloon 12 the balloon may be configured to have a variety of characteristics such as may be desired based on the intended use of the balloon. For example, balloons in general may be provided with a wide variety of functions, including angioplasty and stent delivery functions. Depending on the function of the balloon, the balloon 12 may be provided with a wide variety of performance characteristics, material characteristics, compliance characteristics, and inflation characteristics. Such balloons may be provided with different sizes, lengths, internal diameters, outer diameters, and other physical characteristics. All of these features, and any other feature, characteristic or value of a balloon which may be varied from one balloon to another may be indicated by providing the balloon with a color which corresponds to the particular characteristic which the balloon possesses. The color or colors may be provided according to a predetermined pattern, such as one or more solid colors, stripes, dashes, dots, abstract symbols or any other indicia which may be made readily apparent on the balloon itself, such as by coloring the balloon material in the manner described above, or by coloring or marking the balloon after extrusion.

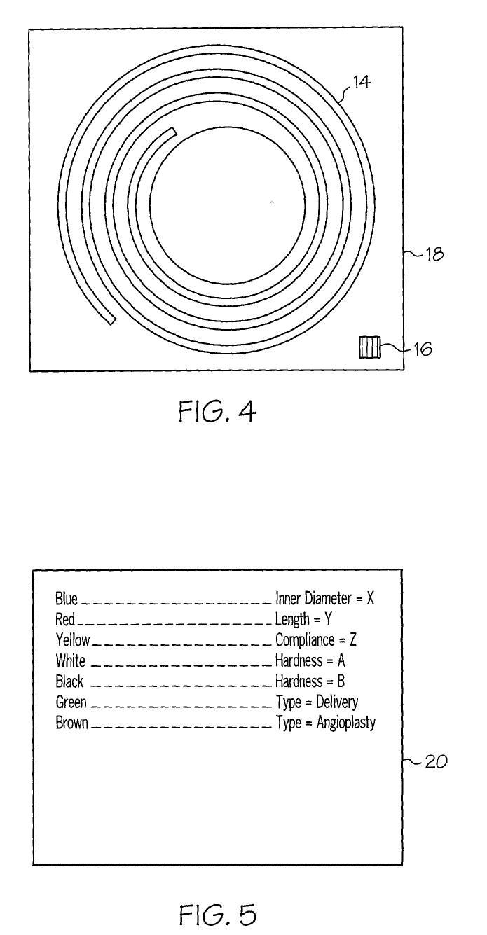

In an at least one embodiment of the invention shown in FIG. 4, it may be preferable to mark the packaging 18 of the balloon or catheter 14 rather than mark the balloon or catheter directly. Where the balloon 12 is colored such as is shown in FIG. 2, and the balloon 12 is intended for use within a body lumen or vessel, the colorant 16 is preferably a biocompatible substance. Where the balloon or catheter packaging 18 is marked instead such as is shown in FIG. 4, the colorant 16 need not be biocompatible.

The various colors and/or patterns of color used to indicate the various characteristics of the balloon 12 may be listed and indexed on a color code chart or key 20 an example of which is show in FIG. 5. The key 20, provides a readily available guide which lists each characteristic which a balloon 12 might be provided with and also lists the color and/or pattern which corresponds to each of those characteristics. A key 20, may thus act as a reference guide to anyone unfamiliar with the particular color code system being employed.

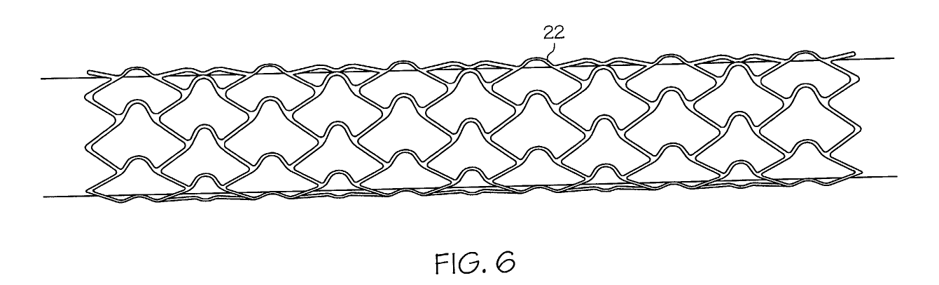

As indicated above, any medical device including balloon 12, shown in FIG. 2, catheter 14, as shown in FIG. 3, may be provided with a color code system to readily identify any and all features of device as may be desired. Where the device is a catheter 14 the catheter 14 may be a guide catheter, a delivery catheter, a balloon catheter, or any other type of catheter known. In the same manner, other medical devices such as stents, grafts, stent-grafts, vena cava filters and others may be provided with a color coding system to indicate the various characteristics of these devices respectively. An example of a stent 22 is shown in FIG. 6. Stent 22, may be configured to have a wide variety of physical and performance characteristics. Any of these characteristics may be indicated by a corresponding color and/or pattern as previously described. In at least one embodiment the stent 22 may be selectively coated with a coating for use in delivering a drug into the body. The stent 22 or the drug delivery coating may be provided with a colorant in order to indicate one or more particular characteristic or quality of the drug to be delivered.

In addition to being directed to the specific combinations of features claimed below, the invention is also directed to embodiments having other combinations of the dependent features claimed below and other combinations of the features described above.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

1. A method for identifying an individual medical device from a group of medical devices comprising the following steps:
providing a group of medical devices;
providing each medical device of the group of medical devices with at least one characteristic;
providing each medical device of the group of medical devices with at least one visible color, wherein the at least one characteristic corresponds to the at least one visible color, such that the at least one characteristic of each medical device of the group of medical devices is identifiable according to the at least one visible color.

2. The method of claim 1 further comprising the step of:
providing a key, the key comprising a list of potential characteristics from which the at least one characteristic is selected from and a list of potential visible colors from which the at least one visible color is selected from, each of the potential visible colors corresponding to at least one of the potential characteristics.

3. The method of claim 1 wherein the group of medical devices comprise catheters.

4. The method of claim 1 wherein the group of medical devices comprise medical balloons.

5. The method of claim 1 wherein the group of medical devices comprise implantable medical devices selected from the group consisting of stents, grafts, stent-grafts, vena cava filters, and any combination thereof.

6. The method of claim 4 wherein the at least one characteristic is selected from at least one member of the group consisting of balloon function, balloon length, balloon inner diameter, balloon outer diameter, balloon compliance, balloon inflation pressure, balloon expansion rate, balloon shape, balloon construction, and any combination thereof.

7. The method of claim 6 wherein each balloon of the group of balloons is represented by a different visible color.

8. The method of claim 1 wherein the at least one color is provided in at least one predetermined pattern, the at least one predetermined pattern further corresponding to the at least one characteristic.

9. A system of identifying a particular characteristic of a medical device comprising: a plurality of medical devices, each of the plurality of medical devices having at least one predetermined characteristic, each of the plurality of medical devices having at least one predetermined color, the at least one predetermined color corresponding to the at least one characteristic, whereby the at least one characteristic of each of the plurality of medical devices is identifiable by the at least one color corresponding thereto.

10. A medical device comprising:
a visible surface, the visible surface having at least one identifiable color, the at least one identifiable color corresponding to at least one characteristic of the medical device, wherein a particular identifiable color will identify a particular characteristic of the medical device.

11. A medical balloon selected from a group of medical balloons wherein each of the medical balloons of the group have a predetermined size, the medical balloon comprising:
a visible surface, the visible surface having a color selected from a group of colors, the medical balloon having a size selected from a group of sizes, each color of the group of colors corresponding to a size selected from the group of sizes, wherein a particular color of the group of colors indicates the size of the medical balloon.

12. A medical balloon selected from a group of medical balloons wherein each of the medical balloons of the group have a predetermined compliance, the medical balloon comprising:
a visible surface, the visible surface having at least one color selected from a group of colors, the medical balloon having at least one compliance characteristic selected from a group of compliance characteristics, each of the colors of the group of colors corresponding to a compliance characteristic selected from the group of compliance characteristics, wherein a particular color of the group of colors will indicate a particular compliance characteristic of the medical balloon.

13. A system for using color to differentiate medical devices according to their characteristics comprising:
a key, the key comprising a list of characteristics and a list of distinct colors, each of the distinct colors corresponding to at least one of the characteristics;
a plurality of medical devices, at least one of the plurality of medical devices having at least one of the characteristics and at least one of the distinct colors corresponding to the at least one of the characteristics according to the key.

14. A system for using color to differentiate medical devices according to their characteristics comprising:
a key, the key comprising a list of predetermined characteristics and a list of distinct colors, each of the distinct colors corresponding to at least one of the predetermined characteristics;
a plurality of medical devices, wherein each of the plurality of medical devices having predetermined characteristics may be readily identifiable by the presence of one or more of the distinct colors, wherein each of the distinct colors corresponds to each of the predetermined characteristics according to the key.

15. A method for identifying an individual medical balloon from a group of medical balloons comprising the following steps:
providing a group of medical balloons;
providing each medical balloon of the group of medical balloons with at least one characteristic;
providing each medical balloon of the group of medical balloons with at least one visible color, wherein the at least one characteristic corresponds to the at least one visible color, whereby the at least one characteristic of each medical balloon is identifiable according to the at least one visible color.

16. A method for identifying an individual medical balloon from a group of medical balloons comprising the following steps:
providing a group of medical balloons;
providing each medical balloon of the group of medical balloons with at least one size characteristic;
providing each medical balloon of the group of medical balloons with at least one visible color, wherein the at least one size characteristic corresponds to the at least one visible color, whereby the at least one size characteristic of each medical balloon is identifiable according to the at least one visible color.
